(19) United States
(12) Patent Application Publication
(10) Pub. No.: US 2013/0151667 A1
(43) Pub. Date: Jun. 13, 2013

(54) METHOD FOR AUTOMATIC INSTALLATION AND SETTING OF SERVER AND APPLICATION PROGRAM FOR THE SAME

(71) Applicants: Wen-Chieh KUO, Taoyuan County (TW); Jui-Tsung HUNG, Taoyuan County (TW)

(72) Inventors: Wen-Chieh KUO, Taoyuan County (TW); Jui-Tsung HUNG, Taoyuan County (TW)

(73) Assignee: DELTA ELECTRONICS, INC., Taoyuan County (TW)

(21) Appl. No.: 13/535,666

(22) Filed: Jun. 28, 2012

(30) Foreign Application Priority Data
Dec. 13, 2011 (TW) 100145946

(51) Int. Cl. G06F 15/16; G06F 15/177

(52) U.S. Cl. 709/219; 709/222

(57) ABSTRACT

A method for automatic installation and setting of a server is disclosed. When a blank server is installed to one of a slot of a server rack and connects to a switch, a boot server retrieves media access controls address of network connection interface in the blank server from the switch, and matches the MAC address and internet protocol address of the blank server. Next, the boot server performing the corresponding installation and setting operation in the blank server based on the IP address of the blank server. Thus, the blank server is able to perform the predetermined role and utilized by the server system immediately after the installation is accomplished.

### BACKGROUND OF THE INVENTION

1. Field of the Invention

The present invention relates to a server, in particular relates to a method for automatic installation and setting of a blank server.

2. Description of Prior Art

Traditionally, a user has to manually perform the installation and setting of an operating system (OS) and application program (AP) via installation files stored in optical discs or hard drives in a brand new computer. Alternatively, the user has to connect the new computer to a remote server host and the server host performs the installation operation in the new computer.

Generally, the installation method performed by a server host starts with storing the operating systems and application programs as iso files in the server host. The blank computers retrieves menu list from the server host. The administrator operates on the blank computers by referring to the menu list and manually selecting the desired operating system and application program to install from the menu list. The server host downloads the corresponding operating system and application program to the blank computers for performing the installation and setting operation based on the selection made by the administrator after the selection is made by the administrator.

With the above method, the administrator is free from the troubles carrying piles of optical discs and many hard drives for manually performing the installation. Nonetheless, the administrator has to operate the menu list manually for selecting the desired installation files. When the there are many blank computers (for example, building a new server system may require installing more than ten thousand blank servers at the same time). Under the circumstance, it is difficult to implement by the manual selection mentioned above.

In addition, each blank server may play different roles, such as a storage server or a computing server, in a server system after the server system is built a server system. During the installation and setting, each blank server is installed with different operating systems and application programs and the setting procedures are also different. With the manual selection methods as mentioned above for performing the installation and setting operation, the building time will be long and it is easy to generate operation errors. Each blank server has a role to play in the server system after the installation. If the blank server is installed with incorrect operating system, then the blank server has to be re-installed with correct operating system and the build time of a server system is longer as a result.

### SUMMARY OF THE INVENTION

The primary objective of the present invention is to provide a method for automatic installation and setting of a server and the application program for the same. After a blank server is inserted into the slot of a server cabinet, the installation and setting of the required operating system and application programs in the blank server is automatically accomplished.

In order to achieve the above objective, a blank server is installed to one of the slots of a server rack and connects to a switch. A boot server retrieves Media Access Control Address (MAC) address of the network connection interface in the blank server from the switch and matches the MAC address of the blank server and its own Internet Protocol (IP) address. Next, the boot server performs the corresponding installation and setting operation in the blank server based on IP address of the blank server,

Compare to prior art, the advantage provided by the present invention is that the boot server assigns a corresponding IP address to the blank server depending on which slot of the which rack the new added blank server is installed in and which connection port of the which switch the new added blank server is connected to. The boot server refers to the corresponding profile based on the location of the blank server, and performs the predetermined installation operation based on the content of the profile. Thus, when the installation and setting operation of the blank server is accomplished, the blank server turns into the predetermined role based on system requirements, for example a storage server or a computing server etc.

The boot server retrieves the MAC address of the blank server from the switch, and matches the MAC address of the blank server and its own IP address. Thus, when an error is generated, the system is acknowledged of the error server location by matching the IP addresses. In addition, when the server is replaced, the system is acknowledged of the server replacement from the address lookup table because the matching between the IP address and the corresponding MAC address is different. The feature is useful in the system management to an administrator.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a server connection schematic diagram of a preferred embodiment according to the present invention;

FIG. 2 is the other server connection schematic diagram of a preferred embodiment according to the present invention;

FIG. 3 is a boot server block diagram of a preferred embodiment according to the present invention; and

FIG. 4 is an installation flow chart of a preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

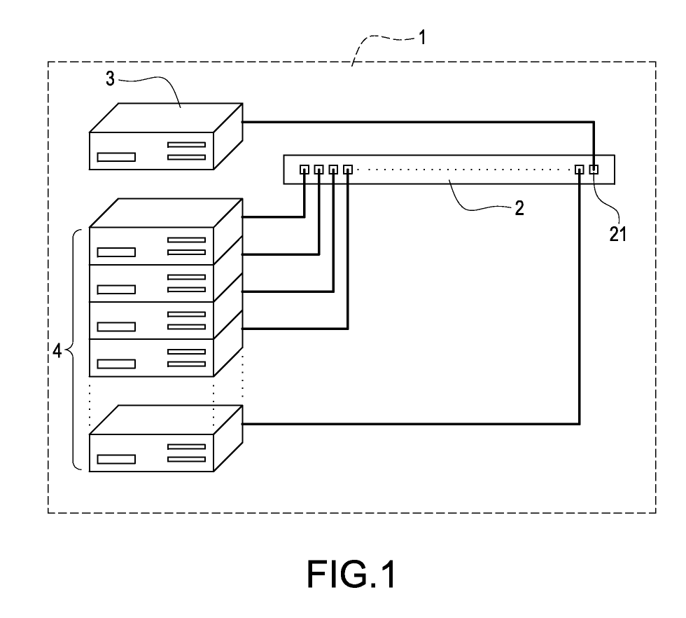

FIG. 1 is a server connection schematic diagram of a preferred embodiment according to the present invention. The method of the present invention for automatic installation and setting for a server is used in a server system. The server system comprises a rack 1 with at least a switch 2, a boot server 3, and at least a blank server 4, the boot server 3. Each blank server 4 individually connects to a connection port 21 on the switch 2.

Server hosts are inserted on a plurality of slots on the rack 1. Each slot individually has a corresponding connection port 21 on the switch 2. When a server host (for example the boot server 3 or the blank server 4) is inserted in one of the slot, the server host connects to the connection port 21 corresponding to the slot. In the embodiment, the boot server 3 and each blank server 4 are installed in the same rack 1, and connects to the same the switch 2, but the scope of the invention is not limited thereto.

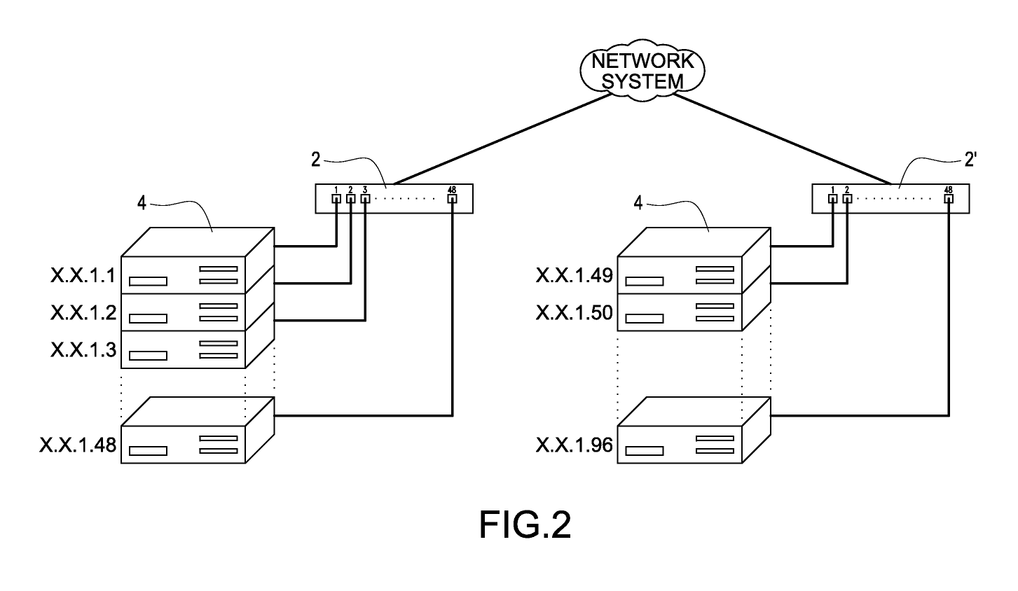

FIG. 2 is the other server connection schematic diagram of a preferred embodiment according to the present invention. In the embodiment, a server host of the server system is installed with a specific application program. The server host acts as the boot server 3 in the server system via the application program. The boot server 3 is a Dynamic Host Configuration Protocol (DHCP) server. The boot server 3 individually allocates an Internet Protocol (IP) address to each connection port 21 of each switch 2. Each IP address permanently binds to the connection port 21 and become a Fixed IP of the connection port 21.

As shown in FIG. 2, for example, each switch 2 has 48 connection port 21 and each connection port 21 is individually allocated with a permanent IP address. In the embodiment, the first connection port 21 of the first switch 2 is allocated with the IP address X.X.1.1, the second connection port 21 is allocated with the IP address X.X.1.2, and the forty-eighth connection port 21 is allocated with the IP address X.X.1.48. The first connection port 21 of the second switch 2′ is allocated with the IP address X.X.1.49 and the like. The above embodiment is one of the preferred embodiments according to the present invention, and the scope of the invention is not limited thereto. In the embodiment, each switch 2, 2′ are connected via network systems, and each the switch 2, 2′ individually connects to a boot server 3, or sharing the same boot server 3 via the network system, and the scope of the invention is not limited thereto.

Each connection port 21 of each switch 2 is allocated with a permanent IP address. When any blank server 4 is inserted into the slot, and connects to the connection port 21 corresponding to the slot, the connection port 21 is allocated with the IP address, which means the blank server 4 is assigned with the IP address. For example, if the blank server 4 connects to the first connection port 21 of the first switch 2, the boot server 3 assigns the above mentioned IP address X.X.1.1 to the blank server 4. Thus, the blank server 4 is allowed to use the IP address and the internet connection of the boot server 3 for downloading required data such as operating system and application programs in order to perform the installation and setting operation (detailed in the following).

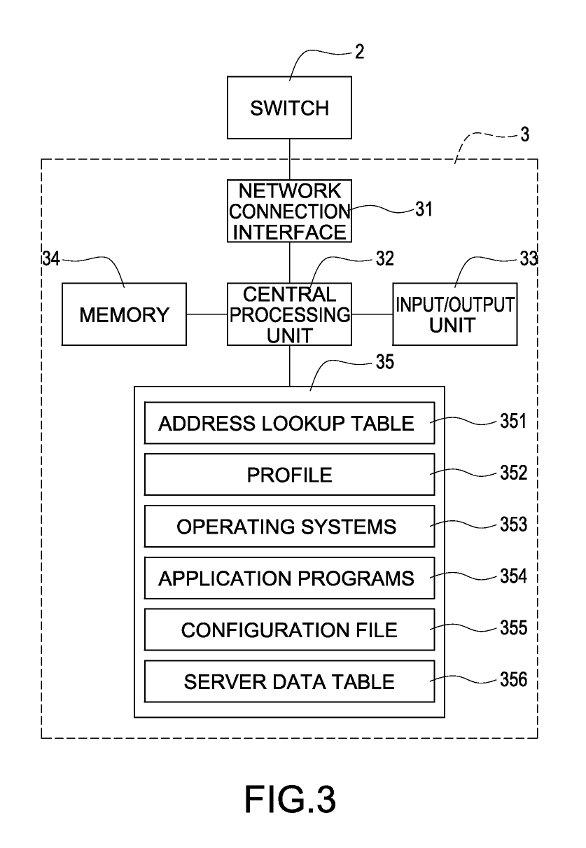

FIG. 3 is a boot server block diagram of a preferred embodiment according to the present invention. The boot server 3 has a host board (not shown in the diagram). The host board is installed with a network connection interface 31, a Central Processing Unit (CPU) 32, an input/output unit 33, a memory 34, and a storage device 35. The CPU unit 32 is electrically connects to the network connection interface 31, the input/output unit 33, the memory 34, and the storage device 35. In the embodiment, the boot server 3 connects to the switch 2 via the network connection interface 31 and allocates a corresponding IP address to each connection port 21 on the switch 2 for performing the installation and setting operation in each blank server 4.

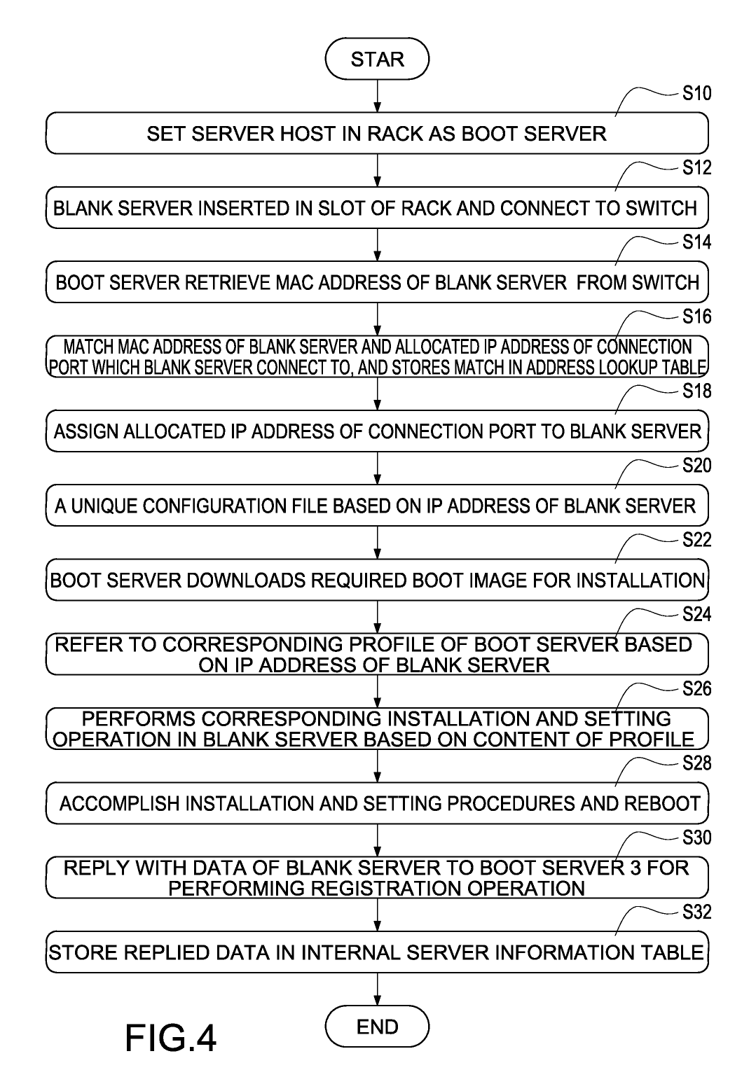

FIG. 4 is an installation flow chart of a preferred embodiment according to the present invention. First, select a server host in the rack land set the server host as the boot server 3 (step S10). Specifically, the server host is installed with a corresponding application program to provide the server host with required functions of the boot server 3. Next, the blank servers 4 are individually inserted several slots of the rack 1 (the example used below only one blank server 4 in the rack 1), and the blank server 4 connects to the switch 2 (step S12). Specifically, the blank server 4 connects to one of the connection port 21 on the switch 2.

When the switch 2 and the blank server 4 are connected, the boot server 3 retrieves Media Access Control (MAC) address of the blank server 4 from the switch 2 (step S14). Specifically, the blank server 4 connects to the switch 2 via the internal network connection interface (such as the network connection interface 31 of the boot server 3). The boot server 3 retrieves MAC address of the network connection interface in the blank server 4 from the switch 2. Thus, the boot server 3 matches MAC address of the blank server 4, and the allocated the IP address of the connection port 21 which the blank server 4 connects to, and stores the match in an address lookup table 351 (for example the address lookup table 351 shown in FIG. 3) (step S16). The address lookup table 351 is stored in the storage device 35 in the boot server 3, but is not limited thereto. After the step S16, the boot server 3 assigns the allocated the IP address of the connection port 21 to the blank server 4 (step S18).

As mentioned above, after the step S16 and the step S18, the boot server 3 bind the IP address to the blank server 4 for administration purposes. For example, when there are error generated in operations of a server host, the system matches the IP address and determines which server host generates the errors (for example via looking up in the address lookup table 351). Further, when server host is replaced, the system is acknowledged that the corresponding MAC address corresponding to the IP address is different and becomes aware that the server host is replaced via looking up in the address lookup table 351. The feature is useful in the system management to an administrator.

After the step S18, the boot server 3 is acknowledged of the IP address of the blank server 4. Accordingly, the boot server 3 performs the corresponding installation and setting operation in the blank server 4 based on the IP address of the blank server 4 (as mentioned in the following).

It should be noted that, the system may set the role of the server host in the system with the IP address of the server host. For example, the system may set 48 server hosts with the IP address from X.X.1.1 to X.X.1.48 as the permanent storage server. The role of the 48 server hosts with the IP address from X.X.1.49 to X.X.1.96 are set as computing server, but the scope of the invention is not limited thereto. When the blank server 4 retrieves the IP address, the boot server 3 performs the corresponding installation and setting operation according to the IP address. When the blank server 4 turns into the role set in advance after the blank server is built with the operating system and application programs based on system. Accordingly, in view of an administrator, not only the manpower required to manually setting the system is waived also the required time to build a server host is shortened.

First, the boot server 3 generates a unique configuration file 355 based on the IP address of the blank server 4 (step S20). The above mentioned configuration file 355 is stored in the storage device 35 of the boot server 3, and the content of the configuration file 355 at least includes data such as host name, user account, and the machine type etc. of the blank server 4. The blank server 4 downloads and receives the configuration file 355, and performs the setting operation according to the content of the configuration file 355.

Next, the blank server 4 connects to the internet via the IP address and downloads the required boot image for installation (step S22). The blank server 4 connects to a Trivial File Transfer Protocol (TFTP) server to download the boot image for installation, or the boot server 3 is stored with the boot images to provide to the blank server 4, and the alternatives are not limited thereto.

As shown in FIG. 3, the storage device 35 of the boot server 3 is further stored with a plurality of profiles 352, a plurality of operating systems 353, and a plurality of application programs 354. After the step S22, the boot server 3 refers to the corresponding profile 352 of the boot server 3 based on the IP address of the blank server 4 (step S24). The boot server 3 performs the corresponding installation and setting operation in the blank server 4 based on the content of the profile 352 (step S26). Specifically, in the step S26, the boot server 3 downloads the predetermined the operating system 353 and the application program 354 to the blank server 4 for performing the installation operation based on the content of the profile 352. At the same time, the boot server 3 downloads the configuration file 355 to the blank server 4 for performing the setting operation.

According to the IP address of the blank server 4, the boot server 3 is acknowledged of the rack and the slot which the blank server 4 is inserted in for determining the role of the blank server 4 in the system upon that the blank server 4 is built and further referring to the corresponding the profile 352. The profile 352 decides the operating system 353 and the application programs 354 to install in the blank server 4 by the boot server 3.

After the above steps are completed, the blank server 4 accomplishes the installation and setting procedures, and reboot (step S28). Next, the blank server 4 performs Power On Self Test on hardware and data after the first reboot such as the CPU status, the quantity and volume of hard drives, the capacity of the memory and the data of the network interface etc. At present, the blank server 4 is fully built instead of a blank server host. Lastly, the blank server 4 replies with the above mentioned data to the boot server 3 for performing registration operation at the boot server 3 (step S30). The boot server 3 accepts registration of the blank server 4 and stores the replied data from the blank server 4 in an internal server data table 356 (step S32). Thus, the boot server 3 acts as a management server for the convenience of administrator management operations.

According to the method of the present invention, a new blank server 4 inserts into a slot of the rack 1, the blank server 4 then automatically accomplishes the installation and setting operation. Upon building, the blank server turns into the predetermined role required by the system. The boot server 3 matches the IP address and the MAC address of the blank server 4 for tracking and managing the blank server 4. Accordingly, the administrator is not required to manually perform the installation and setting operations apart from the installation and setting the boot server 3. When a server system is required to build more than ten thousand server hosts, the method of the present invention saves significant time and manpower required for building servers for the administrator.

The method of the present invention installs an application program and performs setting in a server host to turns the server host into the boot server 3 in the server system. With the application program, the boot server 3 acts as a DHCP server. The server system includes the boot server 3, at least a switch 2, and at least a blank server 4. The boot server 3 and each blank server 4 individually connect to a connection port 21 of the switch 2.

The boot server 3 implements the method for automatic installation and setting for a server of the present invention via executing the application program. When a blank server 4 is added to the system and connects to any connection port 21 of the switch 2, the boot server 3 executes the following steps: a) retrieving the MAC address of the network connection interface in the blank server 4 from the switch 2; b) matching MAC address of the blank server 4 and the allocated IP address of the connection port 21 which the blank server 4 connects to; c) assigning the IP address to the blank server 4; d) generating a unique configuration file 355 based on the IP address of the blank server 4; e) referring to the corresponding the profile 352 based on the IP address of the blank server 4; and f) selecting the predetermined operating system 353 and the application program 354 based on the content of the profile 352, and downloading the operating system 353, the application program 354, and the configuration file 355 to the blank server 4 for performing the installation and setting operation.

As the skilled person will appreciate, various changes and modifications can be made to the described embodiments. It is intended to include all such variations, modifications and equivalents which fall within the scope of the invention, as defined in the accompanying claims.

What is claimed is:

1. A method for automatic installation and setting for a server, the method operated in a server system, the server system including a boot server, at least a switch and at least a blank server, the boot server and the blank server individually connecting to one of the connection ports on the switch, the method for automatic installation and setting of a server including:
a) retrieving MAC (Media Access Control) address of the network connection interface of the blank server from the switch at the boot server;
b) matching the MAC address of the blank server with the allocated IP (Internet Protocol) address of the connection port which the blank server is connected to;
c) assigning the IP address to the blank server following the step b; and
d) performing the corresponding installation and setting operation in the blank server based on the IP address used by the blank server.

2. The method for automatic installation and setting of a server of claim 1, wherein the boot server is a DHCP (Dynamic Host Configuration Protocol) server, each connection port on the switch is allocated with an IP address, and each IP address a is bound to the connection port upon allocation.

3. The method for automatic installation and setting of a server of claim 2, wherein the method further includes a step b1 following the step b: storing the matching status of the MAC address of the blank server and the IP address in an address lookup table in the boot server.

4. The method for automatic installation and setting of a server of claim 2, wherein the method further includes steps following the step c:
e) generating a unique configuration file based on IP address used by the blank server; and
f) downloading the configuration file to the blank server;
wherein, the blank server performs setting operation based on the content of the configuration file in the step d.

5. The method for automatic installation and setting of a server of claim 4, wherein the content of the configuration file at least includes host name, user account, and machine type of the blank server.
(Machine type)

6. The method for automatic installation and setting of a server of claim 2, wherein the method further includes a step d01 before the step d: downloading the boot image to install from a Trivial File Transfer Protocol (TFTP) server at the blank server.

7. The method for automatic installation and setting of a server of claim 2, wherein the boot server has a storage device, the storage device is stored with a plurality of profiles, and the step d further includes following the steps:
d1) referring to the corresponding profile based on IP address used by the blank server; and
d2) performing the corresponding installation and setting operation in the blank server based on the referred profile.

8. The method for automatic installation and setting of a server of claim 7, wherein the boot server refers to the content of the profile and download the predetermined operating system and the application program to the blank server for performing installation operation in the step d2.

9. The method for automatic installation and setting of a server of claim 7, wherein the method further includes the following the steps:
g) accomplishing the installation and setting procedures and reboot at the blank server; and
h) replying the data of the blank server to the boot server for performing registration at the blank server.

10. The method for automatic installation and setting of a server of claim 9, wherein the method further includes a step i following the step h: writing the data replied from the blank server to a server data table in the boot server.

11. A method for automatic installation and setting for a server, the method operated in a server system having a boot server and at least a switch, the boot server connecting to one of the connection ports on the switch, and the boot server is a DHCP server, the boot server have each connection port on the switch allocated with a permanent IP address, the method for automatic installation and setting of a server including:
a) adding a blank server to the server system, and connecting the blank server to one of the connection ports on the switch;
b) retrieving the MAC address of the network connection interface in the blank server from the switch at the boot server;
c) matching, and recording the matching status the MAC address of the blank server and the allocated IP address of the connection port which the blank server connecting to at the boot server;
d) assigning the IP address to the blank server at the boot server following the step c;
e) performing the corresponding installation operation in the blank server based on IP address used by the blank server at the boot server; and
f) performing the corresponding setting operation in the blank server based on IP address used by the blank server at the boot server.

12. The method for automatic installation and setting of a server of claim 11, wherein the boot server has a storage device, in the step c, the boot server stores the matching status in an address lookup table of the storage device.

13. The method for automatic installation and setting of a server of claim 11, wherein the boot server has a storage device, the storage device is stored with a plurality of profiles, at least an operating system, and at least an application program, the step e further includes following the steps:
e1) referring to the corresponding profile based on IP address used by the blank server;
e2) selecting and downloading the predetermined operating system and the application program to the blank server based on the content of the referred profile at the boot server; and
e3) performing the corresponding installation and setting operation in the blank server based the downloaded operating system and the application program.

14. The method for automatic installation and setting of a server of claim 11, wherein the step f further includes:
f1) generating a unique configuration file based on IP address used by the blank server at the boot server;
f2) downloading the configuration file to the blank server at the boot server; and
f3) performing the corresponding setting operation based on content of the configuration file at the blank server.

15. The method for automatic installation and setting of a server of claim 14, wherein the content of the configuration file at least includes host name of the blank server generated by the boot server, user account, and machine type of the blank server.

16. The method for automatic installation and setting of a server of claim 11, wherein the method further includes a step e01 before the step e: downloading the boot image to install from a Trivial File Transfer Protocol server at the blank server.

17. The method for automatic installation and setting of a server of claim 11, wherein further including following the step:
g) accomplishing the installation operation and the setting operation and reboot at the blank server; and
h) replying the data of the blank server to the boot server for performing registration at the blank server.

18. The method for automatic installation and setting of a server of claim 17, wherein the boot server has a storage device, the storage device is stored with a server data table, and the method further includes a step I following the step h: writing the data replied from the blank server to the server data table of the storage device.

19. A application program (AP) installed in a server, the server transformed into a boot server of a server system for executing a method for automatic installation and setting for a server when the application program is downloaded and executed in the server, wherein the server system includes the boot server, at least a switch, and at least a blank server, the boot server and the blank server individually connect to a connection port on the switch, and the boot server is a DHCP server, and the method for automatic installation and setting of a server including:
a) retrieving a Media Access Control (MAC) address of the network connection interface of the blank server from the switch;
b) matching of the MAC address of the blank server and the allocated IP (Internet Protocol) address of the connection port which the blank server connecting to;
c) assigning the IP address to the blank server following the step b;
d) generating a unique configuration file based on IP address used by the blank server,;
e) referring to the corresponding profile based on IP address used by the blank server; and
f) selecting the predetermined operating system and application program based on the content of the referred profile, downloading the operating system, the application program, and the configuration file to the blank server, and performing the installation and setting operation.

20. The application program of claim 19, wherein the boot server has a storage device, the storage device is used for storing the configuration file, the profile, the operating system and the application program, and content of the configuration file at least includes the host name of the blank server generated by the boot server, the user account, and the machine type of the blank server.
